(19) United States
(12) Patent Application Publication
(10) Pub. No.: US 2010/0098956 A1
(43) Pub. Date: Apr. 22, 2010

(54) Coating Material for Protecting Metals, Especially Steel, From Corrosion and/or Scaling, Method for Coating Metals and Metal Element

(76) Inventors: Stefan Sepeur, Wadgassen (DE); Stefan Goedicke, Neunkirchen (DE); Nicole Reuter, Sarreguemines (FR)

Correspondence Address: COLLARD & ROE, P.C., 1077 NORTHERN BOULEVARD, ROSLYN, NY, 11576, US

(21) Appl. No.: 12/086,377

(22) PCT Filed: Dec. 7, 2006
(86) PCT No.: PCT/DE2006/002178

§ 371 Date: Jun. 23, 2008

(30) Foreign Application Priority Data
Dec. 12, 2005 (DE) 10 2005 059 614.2

(51) Int. Cl. H01B 1/04; H01B 1/02; B05D 3/02; B05D 3/06; B32B 15/04

(52) U.S. Cl. 428/457; 252/503; 252/513; 427/384; 427/521

(57) ABSTRACT

The invention relates to a coating material for protecting metals, especially steel, from corrosion and/or scaling, to a method for coating metals and to a metal element. The aim of the invention is to provide a coating material that protects steel from corrosion and/or scaling and that can be welded after heat treatment of the coated steel at temperatures of more than 800° C. For this purpose, substances are provided that render the applied coating material suitable for welding, especially for spot welding. The coating material can be applied by wet chemical methods, it changes its structure when subjected to high temperature processes of more than 600° C. and is suitable as a primer for additional coating materials. It was surprisingly found that when a suitable binder including a suitable filler is used during the high temperature treatment of a curing process, the coating materials of the invention change in such a manner that electrically conducting reactive layers are formed that allow welding and especially spot welding together with the metal substrate even after treatment at temperatures of more than 800° C.

The invention relates to a coating material for protecting metals, especially steel, from corrosion and/or scaling, to a method for coating metals and to a metal element.

Load-bearing steel components such as body parts in the automotive industry are often manufactured from high-strength heat-treated steels. This involves converting the steel into its austenitic form by annealing it at temperatures above 800-900° C., hot-forming the steel and subsequently cooling it again at a sufficiently high cooling speed in order to produce a high-strength, martensitic microstructure. If cooling, and thus hardening takes place in the forming tool, one speaks of press hardening. This method permits the production of high-strength components. To manufacture larger components and components with complex geometries, increasing use is being made of a two-stage forming process involving pre-forming at room temperature (cold forming) followed by hot forming (press hardening) of the pre-drawn part. A general problem encountered with hot forming is scaling of the steel surface.

The term scaling refers to the oxidation of metals by direct reaction with atmospheric oxygen at elevated temperatures. The layer of scale that forms on the steel surface is hard and brittle, and especially during cooling, it flakes off the parent material in clod-like pieces.

The layer of scale damages both the components and the forming tools, which have to be cleaned after each forming step in order to remove flakes of scale. Press hardening of components in the numbers required for series production is thus extremely difficult if the sheet metal used is not protected. Moreover, if satisfactory corrosion protection is to be achieved, the scale has to be sandblasted off the components before they are processed further, since it is an unsuitable basis for subsequent processes such as phosphatizing and cataphoretic dip coating.

Anticorrosive coatings for steel are known from the prior art. Metal coatings of aluminium or aluminium alloys, or of zinc or zinc alloys, can be deposited on the steel by hot-dip or electroplating processes.

In the application EP 1 013 785 A1, the coating of hot-rolled sheet with a metal or a metal alloy is described. The coating in this case is a layer of aluminium or of an alloy of aluminium, iron and silicon, said layer being applied by hot-dip coating (hot-dip aluminizing). A protective layer of this kind admittedly offers effective protection against scaling during the process of heating to austenitizing temperature. However, when used in practice for press-hardening operations, it has limitations. These are particularly noticeable during the shaping of parts with complex geometries. It is mentioned in the DE 102 46 614 A1 that during the hot-dip process described in the EP 1 013 785 A1, an intermetallic alloy phase would form between the steel and the actual coating already during the coating process, and that this intermetallic alloy phase would be hard and brittle and would crack during cold deformation. The microcracks formed would cause the coating to detach from the parent material and thus lose its protective function. From this description and from practical experience in the forming of steel slugs or steel components, it is evident that hot-dip aluminizing is unsuitable for cold forming and thus also unsuitable for a two-step cold- and hot-forming process. In the DE 102 46 614 A1, it is suggested that these problems can be overcome by applying a protective metallic coating from an organic, non-aqueous solution using an electroplating method. The intention here is to deposit layers of aluminium or an aluminium alloy, or of zinc or a zinc alloy. However, the electrodeposition of aluminium on steel is a very time-consuming and expensive process.

Where zinc and zinc alloys are used instead, hot-forming applications, too, are severely limited, because on heating up, most of the zinc oxidizes, or, if a protective gas is being used, vaporizes.

The applications WO 2005/021820 A1, WO 2005/021821 A1 and WO 2005/021822 A1 describe methods of manufacturing various hardened steel parts. In each case, a protective coating consisting of zinc combined with another element that has an affinity for oxygen (especially aluminium) is applied to the steel. In the WO 2005/021821 A1, this protective coating is applied by means of a hot-dip process, in the WO 2005/021820 A1 and WO 2005/021822 A1 by means of a hot-dip or an electroplating process. However, a common feature of all coatings described here that contain zinc as the main element, is that they are very susceptible to oxidation and vaporization at the austenitizing temperatures required for a press-hardening process, and that even traces of dirt (e.g. dust) on the surface will burn and lead to rejection of the part.

From the DE 100 39 404 A1, a method of producing pigment- or filler-containing polysiloxane-based compositions by the sol-gel process is known. In a first step of this process, organosilanes (alkoxysilanes) containing epoxy groups are hydrolysed to a sol, and in a second step, the sol is converted into a gel. The pigments or fillers used have a mean particle diameter of at least 500 nm. The composition may include an aromatic polyol with a maximum average molecular weight of 1,000.

The DE 199 40 857 A1 describes a sol-gel coating material for substrates, especially automobile bodies, painted with a single-coat or multicoat paint system. The intended purpose of the sol-gel coating material is to permit the application, in as short a time as possible, of a scratch-resistant coating atop already-cured paint systems without the occurrence of adhesion problems. To this end, a siloxane-containing coating formulation is modified with organic components. The main constituents of the sol-gel coating material are an acrylate copolymer solution and a sol.

The DE 198 13 709 A1 describes a method of protecting a metallic substrate from corrosion by applying to the substrate a coating composition based on (hetero)polysiloxanes prepared by hydrolysis and condensation processes, and curing said coating composition. The coating composition includes at least one species Z, which reacts, or interacts, with the metal to form a species Y, which has a more negative enthalpy of formation than the species X. The coating composition can be applied by means of a wet-chemical process. The coating is not described as being suitable for welding, let alone spot-welding.

The DE 101 49 148 A1 describes a method of coating metallic surfaces with an aqueous composition that contains at least one organic film former, at least one inorganic compound in particle form and at least one lubricant. The composition described in the DE 101 61 383 A1 contains, in addition to the organic film former, cations and/or hexafluoro complexes of cations and at least one inorganic compound in particle form.

The DE 101 41 687 A1 describes an agent that contains silicon compounds and that is used primarily for producing coatings on surfaces and as a raw material for paints. The agent is a reactive mixture containing at least one alyltrialkoxysilane, at least one alkoxysilane and/or at least one tetraalkoxysilane, at least one hydrous silicic-acid sol, at least one acid and at least one alcohol or at least one glycol.

The DE 100 27 265 A1 describes aluminium coils coated with coloured or effect-forming multilayer coatings. On at least one of their surfaces, the coils have a combination-effect coating consisting of a pigmented powder slurry, a clear lacquer and a sealer based on organically modified ceramic materials.

The EP 0 610 831 A2 describes a method of producing functional coatings using organofunctional silanes, a metal compound and low-volatility oxides. The method involves carrying out a hydrolytic condensation, adding an organic, cross-linkable prepolymer to the hydrolytic condensate, applying the coating solution thus obtained to a substrate and subsequently curing it.

The WO 95/13326 A1 describes a method of producing compositions based on hydrolysable silanes containing epoxy groups, in which a particulate material, a preferably non-ionic surfactant or an aromatic polyol is added to a pre-hydrolysed silicon compound in order to obtain highly scratch-resistant coatings with lasting hydrophilic properties, anticorrosive properties, good adhesion and high transparency.

In the field of anticorrosive coatings applied by wet-chemical methods, protective organic coatings, for example, are known. Some of them are protective enamels filled with zinc pigments. Preferably in the form of an additional sealing layer on an electrogalvanized or hot-dip galvanized steel surface, these offer good corrosion protection for low-temperature applications. However, on account of their insufficient thermal stability, they cannot be used for hot-forming and press-hardening processes involving temperatures above 800° C. The same applies to a large number of organic-based or sol-gel-based anticorrosive coatings.

At the present time, there are no coating materials known from the prior art that are suitable for wet-chemical application, protect the steel from corrosion and/or scaling, and are still suitable for welding following heat treatment of the coated steel at temperatures above 600° C. This suitability for welding particularly includes the suitability of a coated and subsequently heat-treated steel part for spot welding, for which process the coating/component composite requires a sufficiently high electrical conductivity even after the aforementioned heat treatment.

The object of the invention is thus to provide a coating material that can still be welded, in particular spot welded, following heat treatment of the coated steel.

This object is established according to the invention in that the coating material undergoes a change in structure when subjected to high-temperature processes involving temperatures of more than 840° C. and that the coating material is a suitable primer for additional coating materials, that a readily oxidizable organic or inorganic/organic binder containing readily oxidizable organic components is combined with an electrically conducting metallic or non-metallic filler in order to make the applied coating material suitable for welding, that the coating material contains electrically conducting compounds that are resistant to oxidation processes when reducing conditions prevail in the coating and that the coating material can be applied by wet-chemical methods.

Surprisingly, it was found that it is by all means possible to provide a coating material that can be applied by wet-chemical methods, that offers good protection against scaling and that is also suitable for welding, especially for spot welding.

Use of a suitable binder including a suitable filler causes the coating material of the invention to undergo a change during the high-temperature treatment stage of a curing process. This change is of such manner that electrically conducting reactive layers are formed, which, together with the metal substrate, are suitable for welding and especially for spot welding even after treatment at temperatures above 800° C. During the high-temperature process, the binder is oxidized at a temperature of more than 600° C. in a period of less than 10 minutes. The organic constituents burn, forming gaseous products and electrically conducting soot. During the combustion of the organic constituents, a reducing atmosphere forms in the coating layer and protects the metal pigments from oxidation during the high-temperature process. Following oxidative removal of electrically insulating coating constituents, the metal pigments and the non-metallic, electrically conducting particles contained in the coating combine with the substrate surface to form an electrically conductive surface.

Compared with prior-art coatings that cannot be applied by wet-chemical methods, the coatings of the invention also offer the following advantages: the coatings have a very wide range of uses, as in addition to the coil coating technique, they can be applied by other methods such as curtain coating, spray painting, dip-coating, flooding, etc., and can thus be used on three-dimensional components as well as on coils and slugs. The coatings are multifunctional, i.e. in addition to their principal function of protecting against corrosion and/or scale, they can also incorporate tribologically active constituents that enable them to develop a lubricating effect during cold- and hot-forming, thus making external lubricants unnecessary. A further advantage is that the coatings can be applied in very thin layer thicknesses (in the lower μm range), which improves the electrical conductivity and brings material and cost savings. If, following the hot-forming process, even higher electrical conductivity is desired, a thin, electrically conducting primer may be applied atop the coating.

Following the forming process, or high-temperature forming process, the coating material may remain on the surface of the substrate, where it may perform additional functions, e.g. increase the scratch resistance, improve the corrosion protection, fulfil aesthetic aspects (addition of colour, anti-fingerprint properties), protect against tarnishing (in the case of metal or PVD surfaces), alter the electrical conductivity (antistatic effect, insulating effect) and maybe serve as a primer for customary downstream processes (e.g. phosphatizing and cataphoretic dip coating).

Another embodiment of the invention consists in that, to make the applied coating material suitable for welding, an organic, inorganic or organic-inorganic binder matrix contains compounds which, on being heated under reducing conditions at temperatures above 840° C., form a conducting phase, in particular metal salts, metal alkoxides, carbides and phosphides of iron, copper, tungsten and aluminium, and electrically conducting oxides, in particular antimony-tin oxide (ATO) and indium-tin oxide (ITO).

The metal salts are preferably salts of subgroup metals.

Another embodiment of the invention consists in that, to make the coating suitable for welding, the coating material contains electrically conducting compounds that are resistant to oxidation processes at high temperatures, in particular special-steel pigments, pigments or powders of noble metals, copper, tin, graphite and soot, and high-temperature-resistant semiconductors such as silicon carbide.

The coatings' suitability for welding is ensured by the selective addition of electrically conducting compounds that are resistant to oxidation processes at high temperatures and accordingly possess the required electrical conductivity for spot welding both before and during the curing process.

A further embodiment of the invention consists in that the electrically conducting substances that are resistant to oxidation processes when reducing conditions prevail in the coating are selected from pigments and powders of iron, aluminium, zinc, magnesium, graphite and soot.

The above-mentioned reducing conditions may be induced in the coating particularly by the binder.

It is within the scope of the invention that the coating material contains between 5 and 95% by weight, preferably between 10 and 75% by weight, of binder and between 0 and 90% by weight, preferably 25 to 75% by weight, of pigments and/or fillers.

According to the invention, the binder contains organic compounds, especially polyurethanes, polyesters, epoxy resins, alkyd resins, phenolic resins, melamin resins, acrylates and methacrylates, organic-inorganic compounds, especially oligo- and polysiloxanes from the hydrolysis and condensation of alkylalkoxysilanes, alkoxysilanes or mixtures thereof, or silicones, silicone resins or organically modified silicone resins, or purely inorganic compounds, especially silicates, polyphosphates and aluminosilicates, or metals, metal alkoxides and their condensation products, metal oxides and metal salts.

It is also to advantage that the coating material contains metal pigments, in particular aluminium, zinc, iron, tin, copper, magnesium, high-grade steel, silver or other noble metals or metal salts.

These serve to improve corrosion protection and/or to prevent high-temperature corrosion (scale formation).

It may also be expedient that the coating material contains lubricants, in particular natural and synthetic waxes, oils, polymers such as polytetrafluoroethylene and fluoroethylenepropylene, thermoplastics, especially polyethylene and polyamide, stearates, soaps of aluminium, zinc, magnesium and lithium, higher fatty acids, organic compounds of chlorine, phosphorus and sulphur, fluorides of calcium or barium, phosphates, oxides, hydroxides and sulphides of calcium and zinc, and metals, in particular lead, copper, tin, silver, gold, indium and nickel.

It is also within the scope of the invention that the coating material contains greases, in particular inorganic greases, preferably graphite, soot, boron nitride, titanium nitride, molybdenum disulphide and tungsten disulphide.

These greases are particularly suitable for processes carried out at higher temperatures.

The invention furthermore provides for the coating material to contain one or more anticorrosive pigments or corrosion inhibitors, in particular silicates, polyphosphates, tannin derivatives, alkaline sulphonates of alkali and alkaline earth metals, zinc salts of organic nitrogen acids, and phosphates, chromates and molybdates of calcium, magnesium, zinc or aluminium.

The anticorrosion properties are improved in this way.

According to the invention, the coating material is suitable for spot-welding.

The scope of the invention also includes a method for coating metals, especially steel, with the coating material of the invention, the coating material being applied to a substrate by means of a wet-chemical coating process such as knife application, dip-coating, spray-painting, roller application, flooding or curtain coating, and being bonded firmly to the surface of the substrate by means of a curing stage.

According to one version of the invention, curing ensues in a temperature range from room temperature up to 800° C., preferably at temperatures from room temperature up to 300° C. The elevated temperature is initiated by hot air, by radiation in the NIR, IR, UV range, by electron beam or by induction.

It is possible that after ordinary drying or a curing stage of the kind described above, the coating material will show sufficient electrical conductivity to render it suitable for welding.

Another version of the invention consists in that application of the coating material to the substrate is followed by a high-temperature processing stage in which the coating material/substrate composite is heated to a temperature between 840° C. and 1,300° C., preferably between 840° C. and 1,000° C.

The thermal treatment causes a change in the chemical structure of the coating material and is usually also of technical significance for the metal, e.g. it improves the metal's workability (i.e. its forming property) by pressing, forging, etc. The thermal treatment can also be part of a hardening process that is carried out with or without forming. The outcome of the thermal treatment is that the resulting structure shows sufficient electrical conductivity to permit welding by means of standard welding techniques, especially spot welding. In addition, the coating material can be formed by means of all standard cold- and hot-forming processes.

It is furthermore expedient that the high-temperature processing stage takes between one second and several hours, preferably between one second and 30 minutes.

It is within the scope of the invention that the metallic substrate is steel, a steel alloy or a steel provided with a metallic coating, in particular of aluminium, zinc, magnesium, tin or appropriate alloys of these metals, such as aluminium-silicon, aluminium-iron, zinc-iron, zinc-silicon and zinc-aluminium-silicon.

According to the invention, coils, slugs or other components, in particular profiles, rods, wire, pipes, mouldings, forgings or castings, are used as steel substrate.

Finally, the scope of the invention also includes a metal element provided with a coating material according to the invention.

Examples of such metal elements particularly include automotive components (e.g. body and engine parts), components of trains and aircraft, of machines, industrial plant and agricultural equipment, and metal parts used in the construction and mining industries.

The invention is explained in detail below by reference to three embodiments.

### EXAMPLE 1

10 g of graphite powder (particle size <10 μm) are added to 100 g of a 60% silicone polyester solution (e.g. in xylol, obtainable under the trade name Silikoftal) and mixed in thoroughly using a dissolver. 70 g of ethanol, 10 g of carnauba wax dispersion (solids content 20% by weight in white spirit), 50 g of aluminium pigment paste (e.g. Decomet Hochglanz, A1 1002/10, from Schlenk) and 20 g of zinc paste (e.g. Zinkflake GTT, from Eckart) are added to the mixture and stirred in homogeneously with a paddle stirrer (low shearing force) for several hours.

Following appropriate dilution with butyl glycol, the finished coating material is applied to an alkaline degreased steel substrate using a paint spray gun with gravity cup (e.g. Sata Jet, 1.2 mm nozzle), or, in cases of a suitable substrate geometry (flat metal sheet or slug), using a doctor knife, so that a thin, wet film of approx. 10-40 μm thickness is obtained. The coating is cured for about 10 minutes at a surface temperature of 220° C. The coating may also be applied to the metal sheet by roller (e.g. coil coating) and stoved at a peak metal temperature (PMT) of 230-240° C.

### EXAMPLE 2

30 g of graphite powder (particle size <10 μm) are added to 100 g of a 60% silicone polyester solution (e.g. in xylol, obtainable under the trade name Silikoftal) and mixed in thoroughly using a dissolver. 70 g of xylol, 10 g of carnauba wax dispersion (solids content 20% by weight in white spirit) and 30 g of aluminium pigment paste (e.g. Decomet Hochglanz, A1 1002/10, from Schlenk) are added to the mixture and stirred in homogeneously with a paddle stirrer (low shearing force) for several hours.

Following appropriate dilution with butyl glycol; the finished coating material is applied to a grease-free, galvanized steel substrate using a paint spray gun with gravity cup (e.g. Sata Jet, 1.2 mm nozzle), or, in cases of a suitable substrate geometry (flat metal sheet or plate), using a doctor knife, so that a thin, wet film of approx. 10-40 μm thickness is obtained. The coating is cured for about 10 minutes at a surface temperature of 220° C. The coating may also be applied to the galvanized steel sheet by roller (e.g. coil coating) and stoved at a peak metal temperature (PMT) of 230-240° C.

### EXAMPLE 3

50 g of butyl alcohol and 85 g of an iron pigment paste (e.g. STAPA TA Ferricon 200, from Eckart) are added to 100 g of a 60% silicone polyester solution (in xylol, obtainable, for example, under the trade name Silikoftal) and stirred in homogeneously with a low shearing force.

The finished coating material is applied to an alkaline degreased steel substrate using a paint spray gun with gravity cup (e.g. Sata Jet, 1.4 mm nozzle), or, in cases of a suitable substrate geometry (flat metal sheet or slug), using a doctor knife, so that a thin, wet film of approx. 10-40 μm thickness is obtained. The coating is cured for about 10 minutes at a surface temperature of 250° C.

### EXAMPLE 4

250 g of a suitable solvent (e.g. Solvesso 150 aromatics mixture) are added to 100 g of a polyester resin solution (obtainable, for example, under the trade name Desmotherm VP LS 2218) and stirred in homogeneously. 80 g of a platelet-like copper powder (e.g. STANDART Kupferpulver Feinschliff GTT, from Eckart) are added to the diluted polyester resin and stirred in homogeneously with a paddle stirrer (low shearing force). 10 g of graphite powder (particle size <10 μm) and 10 g of a carnauba wax dispersion (solids content 20% by weight in white spirit) are added to the mixture and mixed in thoroughly.

The finished coating material is applied to an alkaline degreased steel substrate using a paint spray gun with gravity cup (e.g. Sata Jet, 1.4 mm nozzle), or, in cases of a suitable substrate geometry (flat metal sheet or slug), using a doctor knife, so that a thin, wet film of approx. 10-40 μm thickness is obtained. The coating is cured for about 10 minutes at a surface temperature of 180° C. The coating may also be applied to the metal sheet by roller (e.g. coil coating) and stoved at a peak metal temperature (PMT) of 230-240° C.

1. Coating material for protecting metals, especially steel, from corrosion and/or scaling, wherein the coating material undergoes a change in structure when subjected to high-temperature processes involving temperatures of more than 840° C. and wherein the coating material is a suitable primer for additional coating materials, wherein a readily oxidizable organic or inorganic/organic binder containing readily oxidizable organic components is combined with an electrically conducting metallic or non-metallic filler in order to make the applied coating material suitable for welding, wherein the coating material contains electrically conducting compounds that are resistant to oxidation processes when reducing conditions prevail in the coating and wherein the coating material can be applied by wet-chemical methods.

2. Coating material according to claim 1, wherein, to make the applied coating material suitable for welding, an organic, inorganic or organic-inorganic binder matrix contains compounds which, on being heated under reducing conditions at temperatures above 840° C., form a conducting phase, in particular metal salts, metal alkoxides, carbides and phosphides of iron, copper, tungsten and aluminium, and electrically conducting oxides, in particular antimony-tin oxide (ATO) and indium-tin oxide (ITO).

3. Coating material according to claim 1, wherein, to make the applied coating material suitable for welding, the coating material contains electrically conducting compounds that are resistant to oxidation processes at high temperatures, in particular special-steel pigments, pigments or powders of noble metals, copper, tin, graphite and soot, and high-temperature-resistant semiconductors such as silicon carbide.

4. Coating material according to claim 1, wherein the electrically conducting substances that are resistant to oxidation processes when reducing conditions prevail in the coating are selected from pigments and powders of iron, aluminium, zinc, magnesium, graphite and soot.

5. Coating material according to claim 1, wherein the coating material contains between 5 and 95% by weight, preferably between 10 and 75% by weight, of binder and between 0 and 90% by weight, preferably 25 to 75% by weight, of pigments and/or fillers.

6. Coating material according to claim 1, wherein the binder contains organic compounds, especially polyurethanes, polyesters, epoxy resins, alkyd resins, phenolic resins, melamin resins, acrylates and methacrylates, organic-inorganic compounds, especially oligo- and polysiloxanes from the hydrolysis and condensation of alkylalkoxysilanes, alkoxysilanes or mixtures thereof, or silicones, silicone resins or organically modified silicone resins, or purely inorganic compounds, especially silicates, polyphosphates and aluminosilicates, or metals, metal alkoxides and their condensation products, metal oxides and metal salts.

7. Coating material according to claim 1 wherein the coating material contains metal pigments, in particular aluminium, zinc, iron, tin, copper, magnesium, high-grade steel, silver or other noble metals or metal salts.

8. Coating material according to claim 1, wherein the coating material contains lubricants, in particular natural and synthetic waxes, oils, polymers such as polytetrafluoroethylene and fluoroethylenepropylene, thermoplastics, especially polyethylene and polyamide, stearates, soaps of aluminium, zinc, magnesium and lithium, higher fatty acids, organic compounds of chlorine, phosphorus and sulphur, fluorides of calcium or barium, phosphates, oxides, hydroxides and sulphides of calcium and zinc, and metals, in particular lead, copper, tin, silver, gold, indium and nickel.

9. Coating material according to claim 1, wherein the coating material contains greases, in particular inorganic greases, preferably graphite, soot, boron nitride, titanium nitride, molybdenum disulphide and tungsten disulphide.

10. Coating material according to claim 1, wherein the coating material contains one or more anticorrosive pigments or corrosion inhibitors, in particular silicates, polyphosphates, tannin derivatives, alkaline sulphonates of alkali and alkaline earth metals, zinc salts of organic nitrogen acids, and phosphates, chromates and molybdates of calcium, magnesium, zinc or aluminium.

11. Coating material according to claim 1, wherein the coating material is suitable for spot-welding.

12. Method for coating metals, especially steel, with coating material according to claim 1, wherein the coating material is applied to a substrate by means of a wet-chemical coating process such as knife application, dip-coating, spray-painting, roller application, flooding or curtain coating, and is bonded firmly to the surface of the substrate by means of a curing stage.

13. Method according to claim 12 for coating metals, wherein curing ensues in a temperature range from room temperature up to 800° C., preferably at temperatures from room temperature up to 300° C., the elevated temperature being initiated by hot air, by radiation in the NIR, IR, UV range, by electron beam or by induction.

14. Method according to claim 12 for coating metals, wherein application of the coating material to the substrate is followed by a high-temperature processing stage in which the coating material/substrate composite is heated to a temperature between 840° C. and 1,300° C., preferably between 840° C. and 1,000° C.

15. Method according to claim 12 for coating metals, wherein the high-temperature processing stage takes between one second and several hours, preferably between one second and 30 minutes.

16. Method according to claim 12 for coating metals, wherein the metallic substrate is steel, a steel alloy or a steel provided with a metallic coating, in particular of aluminium, zinc, magnesium, tin or appropriate alloys of these metals, such as aluminium-silicon, aluminium-iron, zinc-iron, zinc-silicon and zinc-aluminium-silicon.

17. Method according to claim 12 for coating metals, wherein coils, slugs or other components, in particular profiles, rods, wire, pipes, mouldings, forgings or castings, are used as steel substrate.

18. Metal element provided with a coating material according to claim 1.
